(19) United States
(12) Patent Application Publication
(10) Pub. No.: US 2002/0021692 A1
(43) Pub. Date: Feb. 21, 2002

(54) Method and apparatus for transmitting data rate control information in mobile telecommunication system for packet data transmission

(75) Inventors: Hoon Huh, Daejeon-Kwangyeok-shi (KR); Yu-Suk Yun, Seoul (KR); Soon-Young Yoon, Seoul (KR); Jae-Heung Yeom, Seoul (KR); Sang-Hyun Yang, Seoul (KR); Hee-Won Kang, Songnam-shi (KR)

Correspondence Address: Paul J. Farrell, Esq., DILWORTH & BARRESE, LLP, 333 Earle Ovington Blvd., Uniondale, NY, 11553, US

(73) Assignee: SAMSUNG ELECTRONICS CO., LTD., KYUNGKI-DO (KR)

(21) Appl. No.: 09/888,915

(22) Filed: Jun. 25, 2001

(30) Foreign Application Priority Data
Jun. 24, 2000 (KR) 35161/2000

(51) Int. Cl. H04J 1/16

(52) U.S. Cl. 370/352; 370/329

(57) ABSTRACT

There is provided a method and apparatus for transmitting/receiving data rate control (DRC) information in a mobile telecommunication system for transmitting packet data. To determine a data rate on the forward link in a mobile telecommunication system such as an HDR system, DRC information is transmitted on the reverse link only in time for scheduling user data. An access network (AN) transmits a DRC request indicator (DRI) bit or an access terminal (AT) detects preambles of all users or its own preamble in order to control transmission of the DRC information. Along with the DRC information transmission control, some ATs are controlled to transmit pilot channels and RRI channels at different time points from other ATs. Therefore, interference load on the reverse link is reduced and the system capacity of the reverse link is increased.

### BACKGROUND OF THE INVENTION

1. Field of the Invention

The present invention relates generally to a mobile telecommunication system for transmission of packet data, and in particular, to a method and apparatus for transmitting data rate control (DRC) information.

2. Description of the Related Art

Research has actively been made on high data rate transmission (or packet data transmission) in the CDMA (Code Division Multiple Access) mobile communication system. A major mobile communication system having a channel structure suitable for high rate transmission is a so-called HDR (High Date Rate) system standardized by the 3GPP2 (3^{rd} Generation Partnership project 2) organization to reinforce data communication in the IS-2000 system.

The HDR system employs a link adaptation scheme in which a data rate is controlled by adapting a code rate and modulation to channel conditions. A pilot channel, a MAC (Media Access Control) channel, a traffic channel, and a control channel on the forward link are subject to time division multiplexing (TDM) prior to transmission in the HDR system. The forward traffic channel utilizing link adaptation can be transmitted at 13 data rates by combining three modulations, QPSK (Quadrature Phase Shift Keying), 8PSK (8-ary Phase Shift Keying), and 16QAM (16-ary Quadrature Amplitude Modulation), three code rates, 1/4, 3/8 and 1/2, and the number of slots in which a packet is transmitted.

An access terminal (AT) measures the carrier to interference ratio (C/I) of forward pilot channels received from eight effective sectors (active set sectors), estimates channels conditions, and then requests a data rate for a forward traffic channel and a sector from which it will receive data to an access network (AN) on a DRC channel. The DRC information is composed of data rate information in a 4-bit DRC symbol and cell selection information in a 3-bit index by which an 8-bit orthogonal (Walsh) code is determined.

FIG. 1 illustrates the relationship between reverse channels in a typical HDR system. The puncturing patterns of a pilot channel, a DRC channel, and an RRI (Reverse Rate Indicator) channel on the reverse link are shown here.

In FIG. 1, the RRI channel indicates the data rate of a reverse traffic channel and the DRC channel transmits DRC information to an AN as stated before. Each bit of the DRC information transmitted on the DRC channel is repeated once and spread with an 8-bit Walsh code indicating a sector. The result is then spread with a 4-bit Walsh code. Consequently the DRC symbol has a total of 512 chips and repeats itself once so that 1024 chips are filled on the DRC channel. The DRC chips are divided into 16 64-chip TDM slots and TDM-transmitted with the pilot channel and the RRI channel after puncturing in the pattern shown in FIG. 1. Upon receipt of data rates from ATs within the sector on the DRC channels, the AN schedules user data according to the amount of packet data and requested data rate of each user and selects an AT that will receive a data packet in the next slot. The AN transmits the data packet at the requested data rate to the selected AT for one packet period starting from the next slot.

FIG. 2 illustrates the lengths of data packets according to data rates on the forward link in the typical HDR system.

Referring to FIG. 2, the forward traffic channel transmits packets of different lengths according to data rates requested by ATs. After one packet is transmitted, the AN selects an AT to be serviced on the forward traffic channel in the next slot and determines a data rate at which to transmit data to the AT based on DRC information received from the ATs within the sector. The AN transmits a preamble at the start of each packet to inform the destination AT to receive the packet and the length of the packet. The preamble is multiplied by a Walsh code corresponding to a MAC index assigned to the AT and the repeating times of the preamble is determined according to the data rate of the packet. Table 1 shown below lists preamble repetition and the number of preamble chips versus data rate. The AT searches for the preamble by use of the Walsh code corresponding to its MAC index and checks the data rate.

TABLE 1

| Data rate | | Preamble repetition | Chip number |
|---|---|---|---|
| 38.4 | kbps | 32 | 1024 |
| 76.8 | kbps | 16 | 512 |
| 102.4 | kbps | 12 | 384 |
| 153.6 | kbps | 8 | 256 |
| 204.8 | kbps | 6 | 192 |
| 307.2 | kbps | 4 | 128 |
| 614.4 | kbps | 2 | 64 |
| 921.6 | kbps | 2 | 64 |
| 1228.8 | kbps | 2 | 64 |
| 1843.2 | kbps | 2 | 64 |
| 2457.6 | kbps | 2 | 64 |

As stated above, after transmission of one packet on the forward link in the HDR system, the AN schedules user packet data referring to DRC information received from the ATs just before the packet transmission. It is to be noted here that the DRC information is transmitted in each slot on the reverse link. Although the DRC information is unnecessary when no schedule is made out, the DRC information is continuously transmitted on DRC channels. This implies that reverse link resources are continuously occupied, thereby decreasing the system capacity of the reverse link. The problem becomes worse when data is transmitted at a low data rate (e.g., 38.4 kbps and 76.8 kbps in FIG. 2) on the forward link. Since DRC information is used only at the time for scheduling before complete transmission of a packet, untimely DRC information for scheduling is useless. Therefore, when data is transmitted at a low data rate, which implies that a long packet is transmitted, that is, more slots are used, the number of slots used for transmission of unnecessary DRC information is increased. The continuous transmission of the DRC channels significantly increases interference load on the reverse link. Accordingly, if transmission of the DRC channels is discontinued when DRC information is not needed, interference is reduced and the system capacity on the reverse link is increased.

### SUMMARY OF THE INVENTION

An object of the present invention is, therefore, to provide a method and apparatus for transmitting DRC information used to determine a data rate for the forward link on the reverse link only when scheduling is needed in a mobile telecommunication system like an HDR system.

Another object of the present invention is to provide a method and apparatus for reducing interference load on the reverse link in a mobile telecommunication system like an HDR system.

A further object of the present invention is to provide a method and apparatus for increasing the system capacity of the reverse link in a mobile telecommunication system like an HDR system.

Still another object of the present invention is to provide a method and apparatus for reducing interference load on the reverse link for a DRC information non-transmission period in a mobile telecommunication system like an HDR system.

The foregoing and other objects of the present invention are achieved by providing a method and apparatus for transmitting/receiving DRC information in a mobile telecommunication system for transmitting packet data. To determine a data rate on the forward link in a mobile telecommunication system such as an HDR system, DRC information is transmitted on the reverse link only in time for scheduling user data. An AN transmits a DRI bit or an AT detects preambles of all users or its own preamble in order to control transmission of the DRC information. Along with the DRC information transmission control, some ATs are controlled to transmit pilot channels and RRI channels at different time points from other ATs. Therefore, interference load on the reverse link is reduced and the system capacity of the reverse link is increased.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates the puncturing patterns of a pilot channel, a DRC channel, and an RRI channel on the reverse link in a typical HDR system;

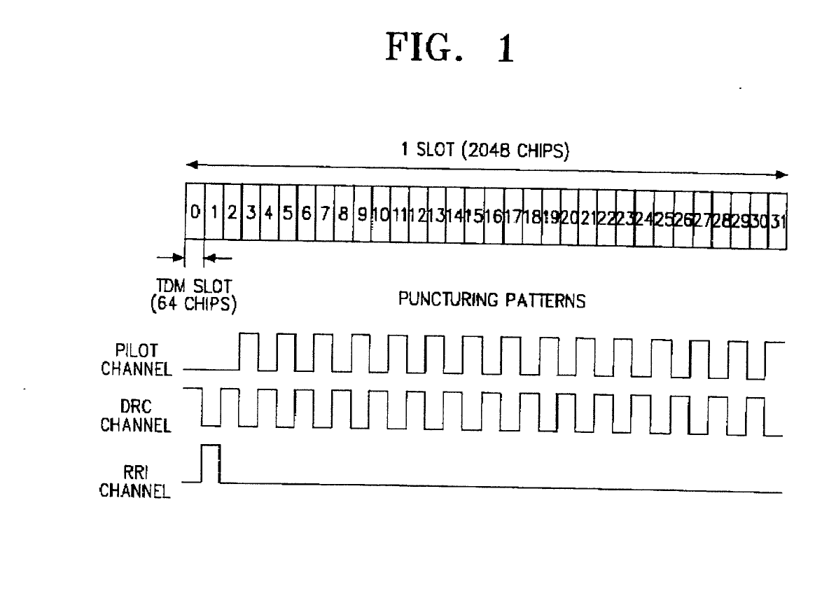

FIG. 2 illustrates the lengths of data packets versus data rates on the forward link in the typical HDR system;

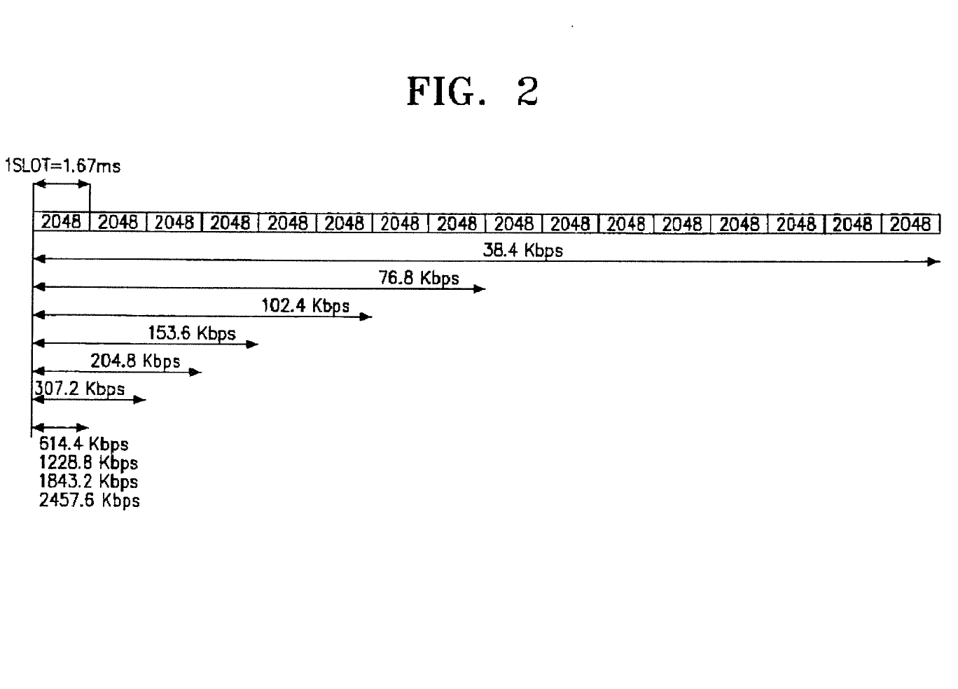

FIG. 3 illustrates the slot transmission/reception relationship between the forward link and the reverse link in a DRC channel transmission control operation according to an embodiment of the present invention;

FIG. 4 is a flowchart illustrating the DRC channel transmission control operation according to the embodiment of the present invention;

FIG. 5 is a block diagram of an AN transmitter according to the embodiment of the present invention;

FIG. 6 is a block diagram of an AT transmitter according to the embodiment of the present invention;

FIG. 7 illustrates the slot transmission/reception relationship between the forward link and the reverse link in a DRC channel transmission control operation according to another embodiment of the present invention;

FIG. 8 is a flowchart illustrating the DRC channel transmission control operation according to the second embodiment of the present invention;

FIG. 9 is a block diagram of an AT transmitter according to the second embodiment of the present invention;

FIG. 10 is the slot transmission/reception relationship between the forward link and the reverse link in a DRC channel transmission control operation according to a third embodiment of the present invention;

FIG. 11 is a flowchart illustrating the DRC channel transmission control operation according to the third embodiment of the present invention;

FIG. 12 is a block diagram of an AT transmitter according to the third embodiment of the present invention; and

FIGS. 13A, 13B, and 13C illustrate transmission of pilot channels and RRI channels for a DRC channel non-transmission period according to a fourth embodiment of the present invention.

### DETAILED DESCRIPTION OF THE PREFERRED EMBODIMENTS

Preferred embodiments of the present invention will be described hereinbelow with reference to the accompanying drawings. In the following description, well-known functions or constructions are not described in detail since they would obscure the invention in unnecessary detail.

It is to be clarified that the present invention provides an apparatus and method for transmitting DRC information on the reverse link only when scheduling is needed, for use in determining a data rate for the forward link in a mobile telecommunication system like an HDR system. That is, when an AN intends to transmit another packet in an HDR system, ATs transmit DRC information just before the previous packet is completely transmitted. According to the present invention, a decision is first made on when to transmit DRC information and the DRC information is transmitted only at the decided time. Pilot channels and RRI channels are transmitted at different time points according to users in order to reduce interference load on the reverse link while the DRC information is not transmitted. Decision as to whether DRC information is to be transmitted at the current time point and selective transmission of the DRC information based on the decision result will be described in Embodiment 1 to Embodiment 3. Embodiment 4 offers a method of reducing interference load on the reverse link by transmitting pilot channels and RRI channels at different time points according to users, incorporating Embodiment 1 to Embodiment 3 therein.

Embodiment 1

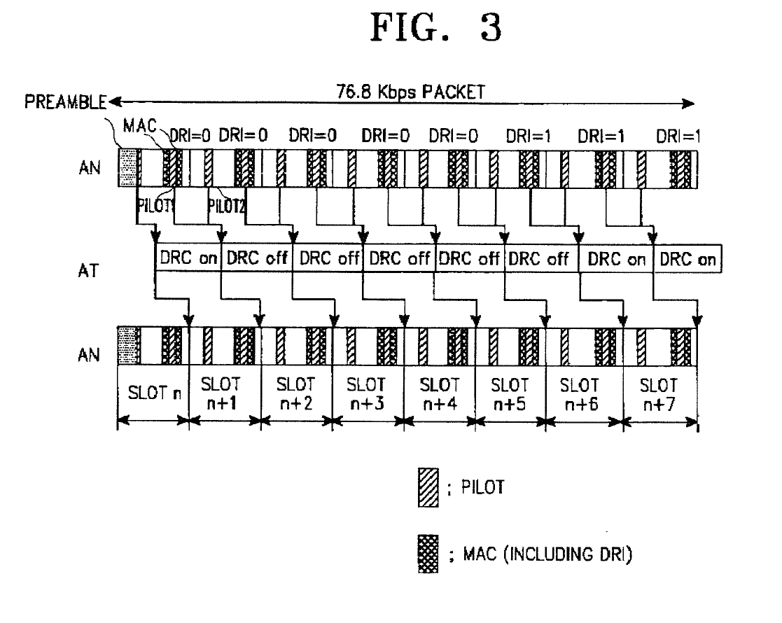

FIG. 3 illustrates the relationship in slot transmission/reception between the forward link and the reverse link in a DRC channel transmission control operation according to a first embodiment of the present invention. This embodiment is characterized by control of DRC channels with the introduction of a DRI (DRC Request Indicator) bit. While the following description focuses on the data rate of 76.8 kbps, it is a mere exemplary application. Obviously, the first embodiment is applicable to any data rate.

Referring to FIG. 3, an AN controls transmission of DRC channels from all ATs by informing them whether it needs to receive reverse DRC channels. The AN transmits the information in a DRI bit on a MAC channel. The DRI bit indicates whether DRC information is needed for scheduling after a predetermined slot period. The DRC information is needed when transmission of the forward packet is terminated in the predetermined slot period and the AN must select the next AT and a data rate. The DRI bit is set to 1 if the transmission of the forward packet is terminated in the predetermined slot and to 0 if the transmission of the current forward packet continues. If the AN requests DRC information within the predetermined slot period and receives the requested information, it determines a data rate for the next packet to transmit. Assuming that the AN is to transmit a new packet in a second transmission period while transmitting a packet to an AT in a first transmission period having a plurality of slots, the AN makes out a schedule to determine an AT to receive the new packet in the second transmission period and a data rate for the packet in the latter half of the last slot of the first transmission period. For this purpose, the AN transmits a DRI bit requesting the DRC information to ATs in the predetermined slot of the first transmission period. The predetermined slot is located at least two slots before the last slot. Preferably, the predetermined slot is the second slot from the last slot. The predetermined slot may indicate the first two slots from the last slot and the last slot in consideration of the case that a packet is completely transmitted in one slot in the second transmission period. For example, if the last slot is 16^{th} slot, the predetermined slot is 14^{th} slot or 14^{th}, 15^{th} and 16^{th} slots. When necessary, the predetermined slot can be set to a different value.

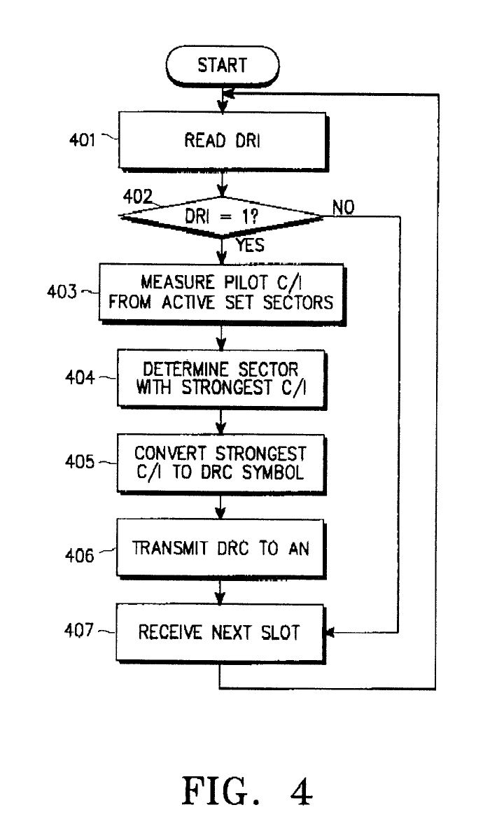

FIG. 4 is a flowchart illustrating a DRC channel transmission control operation according to the first embodiment of the present invention. This is an algorithm of controlling transmission of DRC channels from the ATs by the DRI bit.

Referring to FIG. 4, an AT reads a DRI bit from a forward MAC channel signal in step 401 and checks whether the DRI bit is 1 or 0 in step 402. If the DRI bit is 1, the AT measures the pilot CI of each effective sector (active set sector) in step 403, determines a sector corresponding to the highest C/I in step 404, converts the highest C/I to a corresponding DRC symbol in step 405, and transmits the DRC symbol to the AN in step 406. In step 407, the AT receives the next slot and returns to step 401. As well known, the DRC symbol conversion is performed by mapping the C/I to the corresponding DRC symbol.

On the other hand, if the DRI bit is 0 in step 402, the AT jumps to step 407.

Returning to FIG. 3, the DRI bit in an nth forward slot controls the DRC channel in an (n+1)th reverse slot. The DRC channel arrives in an (n+2)th slot and determines a data rate for an (n+3)th forward slot. DRC information must be requested three slots before the current packet is completely transmitted in the first transmission period, that is, in the second slot from the last slot of the first transmission period, so that the DRC information can be received in time for scheduling to determine the data rate of a new packet to be transmitted in the second transmission period. Therefore, the AN transmits the DRI bit set to 1 three slots before termination of packet transmission and transmits DRI bit set to Os in the other slots. If a packet is as long as N slots, the DRC channel need not be transmitted in (N−3) slots. The ratio of the number of slots for non-DRC channel transmission to the total number of slots in a packet is (N−3)/N. Table 2 illustrates the ratio of the number of slots for non-DRC channel transmission to the total number of slots versus data rates. If packet length is three slots or less, the DRC channel is transmitted in all slots. Interference load caused by transmission of the DRC channel in a slot period can be reduced at a data rate of 153.6 kbps or below and at 307.2 kbps (long packet).

TABLE 2

| | | | Slots for non-DRC |
|---|---|---|---|
| Data rate | | Slots per packet | channel transmission (%) |
| 38.4 | kbps | 16 | 81.25 |
| 76.8 | kbps | 8 | 62.5 |
| 102.4 | kbps | 6 | 50 |
| 153.6 | kbps Short | 4 | 25 |
| 153.6 | kbps Long | 16 | 81.25 |
| 204.8 | kbps | 3 | 0 |
| 307.2 | kbps Short | 2 | 0 |
| 307.2 | kbps Long | 8 | 62.5 |
| 614.4 | kbps | 1 | 0 |
| 921.6 | kbps | 2 | 0 |
| 1228.8 | kbps | 1 | 0 |
| 1843.2 | kps | 1 | 0 |
| 2457.6 | kps | 1 | 0 |

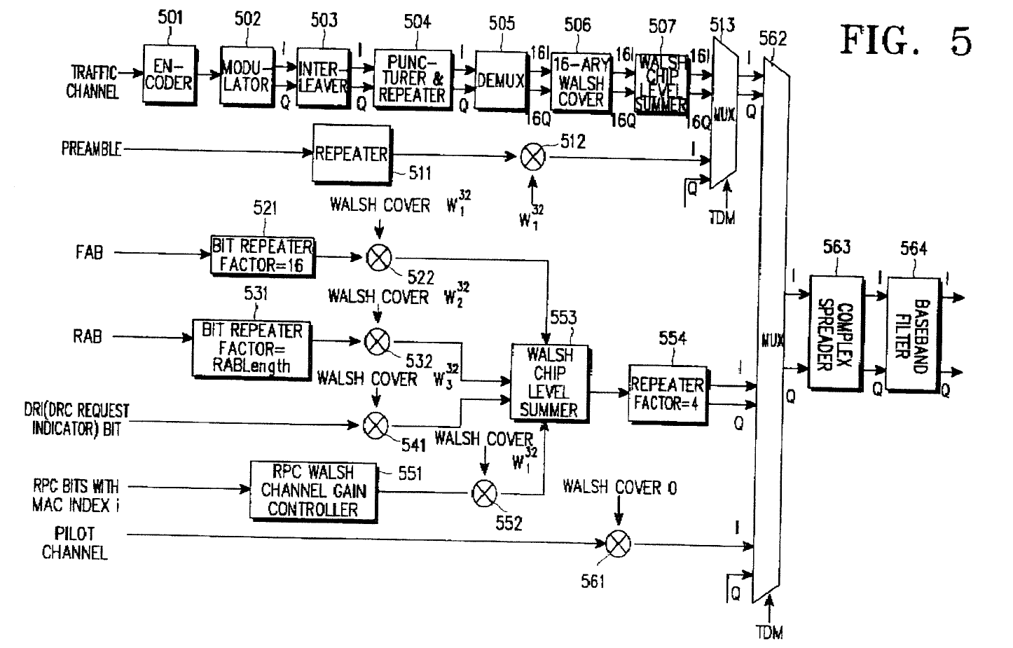

FIG. 5 is a block diagram of an AN transmitter according to the first embodiment of the present invention. The transmitter is characterized by the introduction of the DRI bit.

Referring to FIG. 5, a traffic channel is encoded in an encoder 501, modulated in QPSK, 8PSK, or 16QAM according to a data rate in a modulator 502, and interleaved in an interleaver 503. The interleaved traffic channel signal is punctured and repeated according to the data rate in a puncturer & repeater 504. A demultiplexer (DEMUX) 505 outputs 16 successive bits of the repeated signal on 16 parallel channels. A Walsh cover unit 506 Walsh-covers the 16 channels with 16 Walsh codes and a Walsh chip level summer 507 sums the Walsh-covered channel data at a chip level. A preamble is repeated according to the data rate in a preamble repeater 511 and spread with a Walsh code assigned to a reverse power control channel in a Walsh spreader 512. A multiplexer (MUX) 513 multiplexes the outputs of the Walsh chip level summer 507 and the spread preamble received from the Walsh spreader 512 in such a way that the preamble is located at the start of the traffic channel.

Now there will be given a detailed description of the transmitter structure associated with the DRI bit to which the present invention pertains. A pilot channel, an FA (Forward Activity) bit or an FAB, and an RA (Reverse Activity) bit or an RAB are respectively multiplied by Walsh codes #0, #1, and #2 and transmitted on a forward MAC channel. The other 29 Walsh codes are multiplied by reverse power control (RPC) bits for users prior to transmission. One of the 29 Walsh codes assigned to the RPC bits can be assigned for transmission of the DRI bit. For example, Walsh code #3 can be assigned to the DRI bit. According to the structure of the AN transmitter of the present invention, an FA bit is repeated 15 times (occurs 16 times) in a repeater 521 and multiplied by Walsh code #1 in a multiplier 522. An RA bit occurs as many times as a RABLength factor in a repeater 531 and is multiplied by Walsh code #2 in a multiplier 532. A DRI bit is multiplied by Walsh code #3 in a multiplier 541. An RPC Walsh channel gain controller 551 controls the gain of an RPC channel and a multiplier 552 multiplies the gain-controlled RPC bits by the other Walsh codes, respectively. A Walsh chip level summer 553 sums the signals received from the multipliers 533, 532, 541, and 552 at a chip level. The sum occurs four times in a MAC channel repeater 554 and is transmitted before and after the second pilot burst in each slot by halves. The pilot channel signal is multiplied by Walsh code #0 in a multiplier 561. A second MUX 562 connects the output of the first MUX 513, the output of the MAC channel repeater 554, and the output of the multiplier 561 as shown in FIG. 3. The output of the second MUX 562 is subject to complex spreading in a complex spreader 563 and filtering in a baseband filter 564 prior to transmission.

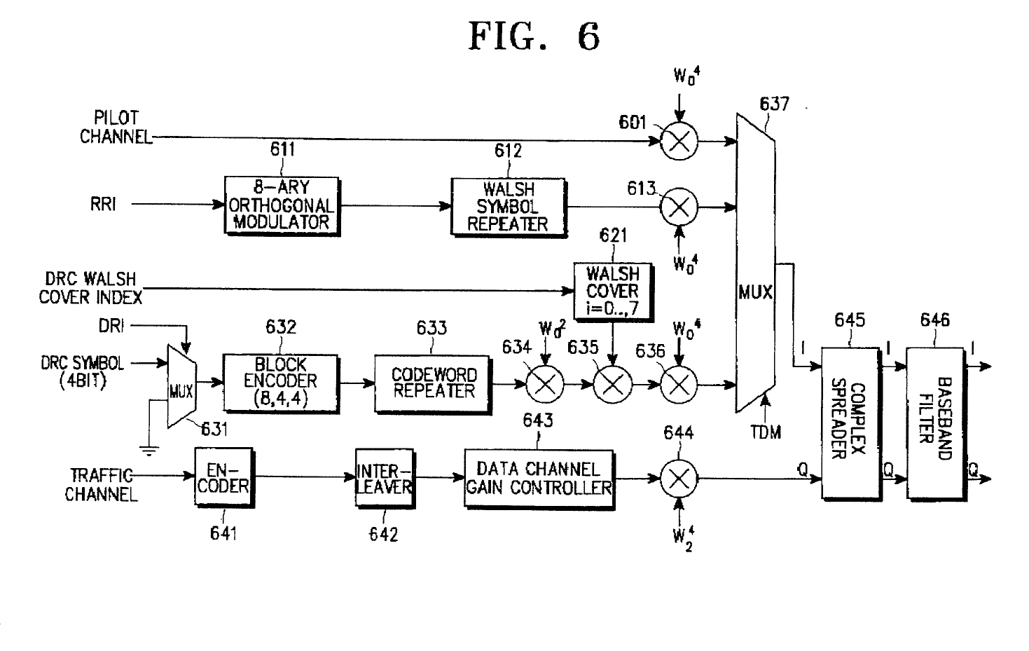

FIG. 6 is a block diagram of an AT transmitter according to the first embodiment of the present invention. This transmitter is also characterized by the introduction of the DRI bit. A description of an AT receiver for receiving the DRI bit related with the present invention from an AN will be omitted and only the structure of the AT transmitter associated with determining whether a DRC symbol is to be transmitted based on the DRI bit related with the present invention will be described hereinbelow in detail.

Referring to FIG. 6, a pilot channel is multiplied with Walsh code #0 in a multiplier 601. An RRI channel is modulated to an 8-bit Walsh symbol in an 8-ary orthogonal modulator 611, repeated 63 times in a Walsh symbol repeater 612, and multiplied with Walsh code #0 in a multiplier 613. If the DRI bit is 0, a MUX 631 passes a DRC symbol and if the DRI bit is 0, it blocks the DRC symbol. That is, the MUX 631 acts as a selector for selecting the DRC symbol according to the DRI bit. The DRC symbol is block-encoded in a block encoder 632 and the codeword is repeated in a repeater 633. The output of the repeater 633 is multiplied with Walsh codes in a series of multipliers 634, 635, and 636. A MUX 637 TDM-multiplexes the spread signal with the pilot signal and the RRI.

A traffic channel is encoded in an encoder 641, interleaved in an interleaver 642, and multiplied by a data channel power gain in a gain multiplier (gain controller) 643. The output of the multiplier 643 is multiplied by Walsh code #2 in a multiplier 644. The outputs of the MUX 637 and the multiplier 644 are output to the in-phase (I) arm and the quadrature (Q) arm, respectively. The I arm and the Q arm are spread in a complex spreader 645 and filtered in a baseband filter 646 prior to transmission.

Embodiment 2

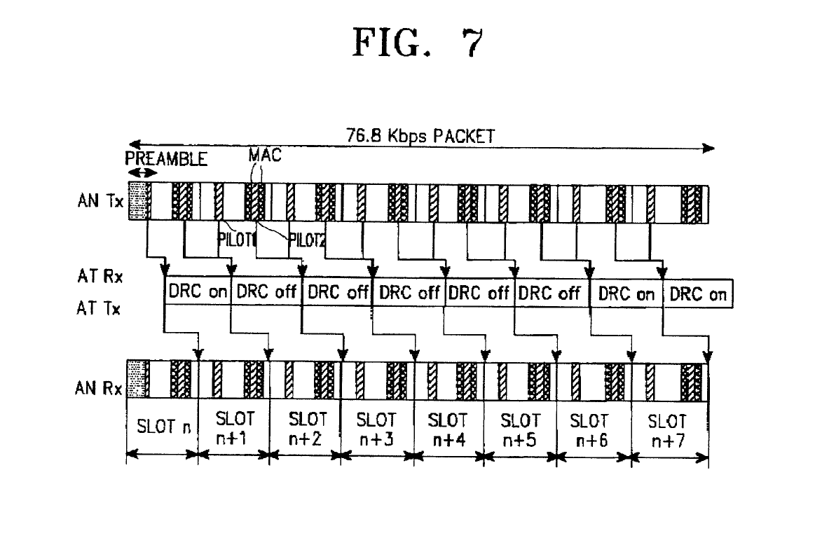

FIG. 7 illustrates the relationship in slot transmission/reception between the forward link and the reverse link according to a second embodiment of the present invention. In the second embodiment, transmission of DRC channels is controlled by allowing an AT to search for preambles of all ATs within the service area of an AN. According to the second embodiment, the AT determines an AT that communicates packet data with the AN by detecting the preambles of all the ATs and transmits DRC information in a predetermined slot period before the packet data is completely transmitted.

If each AT also searches for the preambles of the other ATs, it can find out how long the current forward packet is. Thus, the AT does not transmit its DRC channel until scheduling is needed. That is, each AT checks whether its DRC channel is to be transmitted or not and as a result, it transmits the DRC channel only in time for scheduling. The DRC channel transmission is controlled in this manner. As stated before, a preamble is multiplied with a Walsh code according to a MAC index assigned to an AT and the length of a packet is variable depending on a data rate. Therefore, each AT measures energy by decoding a preamble with Walsh codes corresponding to MAC indexes assigned to all the ATs and compares the energy measurement with preamble repetition times shown in Table 1, thereby finding out the length of the current packet and locating the start and end slots of the packet. After receipt of the first pilot burst in an nth slot, a DRC channel transmits DRC information for an (n+2)th slot. Therefore, the AT transmits the DRC channel two slots before the end slot of the packet. Since one slot is taken to know the length of the packet after the start slot is located, the AT transmits the DRC channel in the start slot, too. Therefore, the number of slots that need not be transmitted is (N−3), and the ratio of the number of slots for the non-DRC channel transmission to an N-slot packet is (N−3)/N as in the first embodiment.

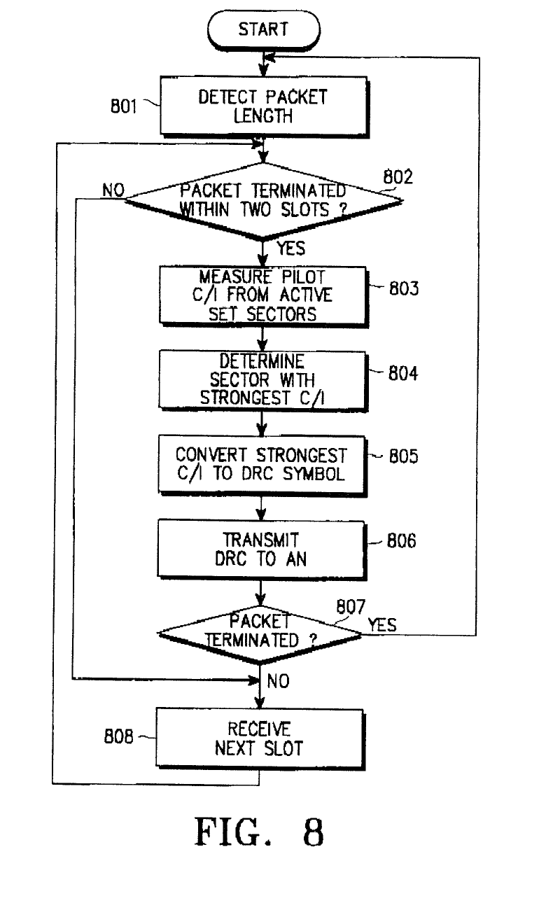

FIG. 8 is a flowchart illustrating a DRC channel transmission control operation according to the second embodiment of the present invention.

Referring to FIG. 8, the AT searches for the preambles of all ATs and determines the length of the current packet in step 801. That is, each of ATs within the service area of the AN determines an AT which is receiving a packet from the AN by multiplying a received preamble with a plurality of predetermined orthogonal codes, mainly Walsh codes, assigned to the ATs and detects the length of the packet from the preamble. In step 802, the AT determines whether the current packet will be terminated within two slots. If the current packet is terminated within two slots, the AT measures the pilot C/I of effective sectors (active set sectors) in step 803 and determines the highest C/I and a sector corresponding to the highest C/I in step 804. The AT converts the determined C/I to a corresponding DRC symbol in step 805 and transmits the DRC symbol to the AN in step 806. On the other hand, if the current packet is not terminated within two slots in step 802, steps 803 to 807 are omitted.

Upon termination of the packet transmission in step 807, the AT returns to step 801, searches for preambles of all the ATs, and reads the length of the next packet. If the packet transmission is not completed in step 807, the AT receives the next slot in step 808 and returns to step 802. In step 802, the AT checks whether the current packet will be terminated within two slots in the received slot.

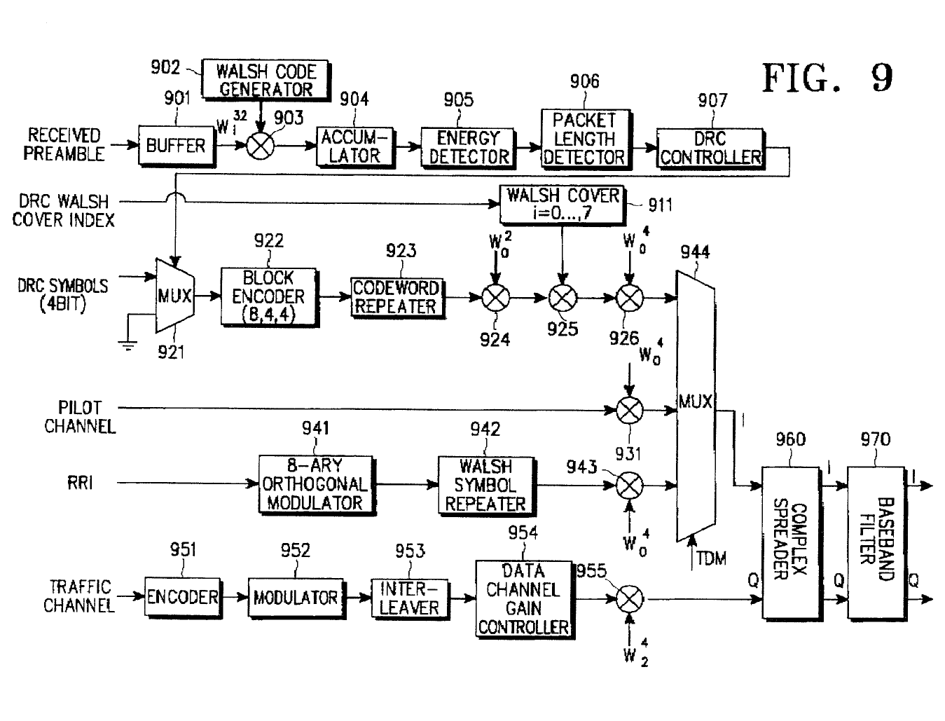

FIG. 9 is a block diagram of an AT transmitter according to the second embodiment of the present invention. The AT transmitter is characterized by searching for preambles of all ATs for control of the DRC channel. The structure of the AN transmitter related with the pilot channel, the RRI channel, and the traffic channel is the same as that shown in FIG. 6. Therefore, a description will be made on only the transmitter structure related with decision about whether to transmit a DRC symbol or not based on the preambles of all the ATs.

Referring to FIG. 9, upon receipt of a preamble, a preamble buffer 901 stores it. A Walsh code generator 902 generates Walsh codes for all the ATs within the sector. A multiplier 903 multiplies the preamble stored in the buffer 901 by the Walsh codes. An accumulator 904 accumulates the product received from the multiplier 903 and an energy detector 905 detects energy from the accumulation. A packet length detector 906 detects packet length from the output of the energy detector 905. Since a period suitable for DRC symbol transmission can be known from the packet length, a DRC controller 907 controls a MUX 921 to selectively transmit the DRC symbol as shown in FIG. 7. The DRC controller 907 controls the MUX 921 to pass the DRC symbol two slots before the packet transmission is completed and to block the DRC symbol in the other slots. That is, if the length of the packet is shorter than three slots, the DRC symbol is transmitted all the time.

In the case where an AT among a plurality of ATs receives packet data from an AN in a first transmission period including a plurality slots, the AT transmits a DRC symbol in slots from a predetermined slot before the end of the first transmission period (two slots before the last slot) to request a data rate for packet data to be transmitted in a second transmission period after the first transmission period. This operation can be performed in ATs that are not receiving the packet data from the AN in the first transmission period as well as the AT receiving the packet data in the first transmission period. That is, if terminals receiving packet data from the AN in the first transmission period is a first group and terminals that are not receiving the packet data from the AN in the first transmission period is a second group, the second group transmits DRC symbols to the AN in the predetermined slot before the transmission of the packet data to the first group is completed. The first group also transmits DRC symbols to the AN in the predetermined slot before the transmission of the packet data is completed.

Embodiment 3

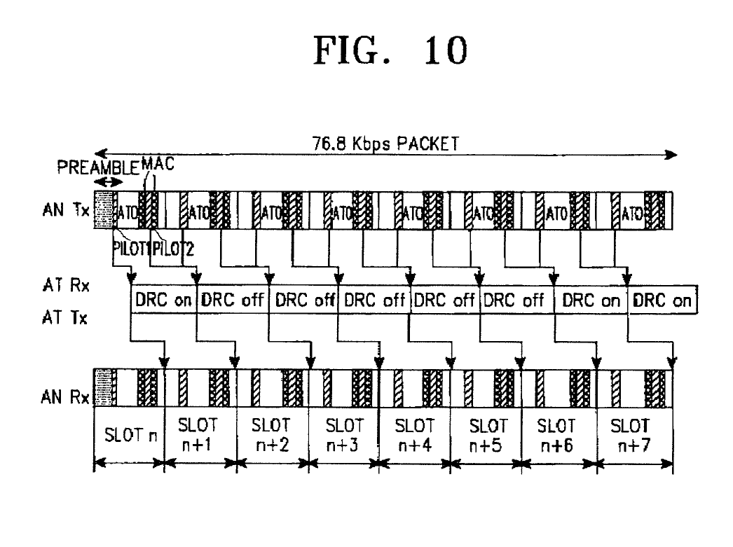

FIG. 10 illustrates the relationship in slot transmission/reception between the forward link and the reverse link in a DRC channel transmission control operation according to a third embodiment of the present invention. In this embodiment, the DRC channel of an AT receiving the current forward channel is controlled.

Referring to FIG. 10, since only the DRC channel of an AT receiving a packet from the AN is controlled in the third embodiment of the present invention, there is no need for a detector for detecting the preambles of the other ATs as compared to the second embodiment. The AT assigned to the current forward traffic channel can detect packet length and locate the start and end slots of the packet by searching for the preamble destined for the AT. The AT can also find out a time period in which DRC information is not needed until the scheduling time before the packet is completely transmitted. As in the second embodiment, the DRC channel is transmitted in the start slot and the last two slots of the packet.

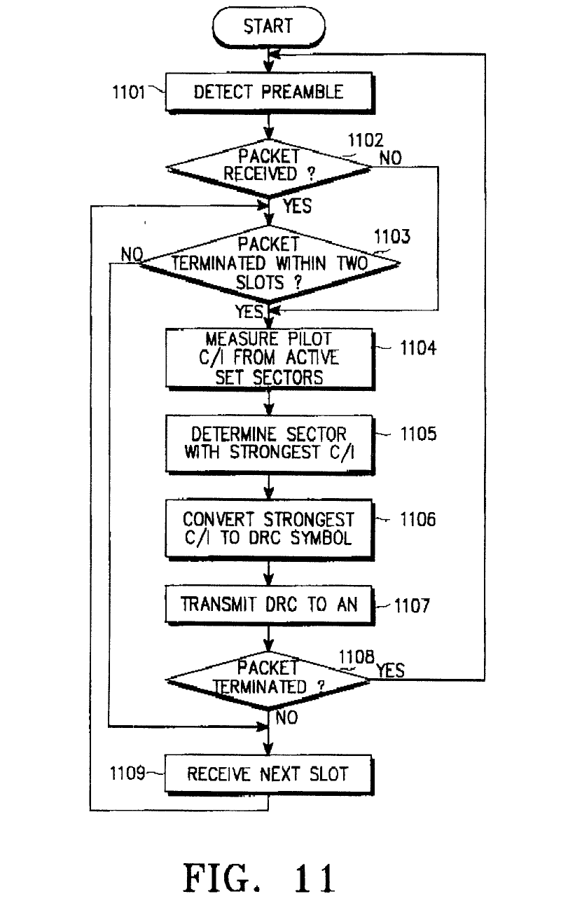

FIG. 11 is a flowchart illustrating a DRC channel transmission control operation in which the DRC channel of the AT receiving the forward traffic channel is controlled according to the third embodiment of the present invention.

Referring to FIG. 11, the AT searches for a preamble transmitted from the AN in step 1101 and determines whether it has received a packet in step 1102. Upon receipt of the packet, the AT determines whether the packet will be terminated within two slots in step 1103. If it is, the AT measures the pilot C/I of effective sectors in step 1104, determines the highest C/I and a sector corresponding to the highest C/I in step 1105, maps the highest C/I to a corresponding DRC symbol in step 1106, and transmits the DRC symbol to the AN in step 1107. On the other hand, if the packet will not be terminated within two slots in step 1103, the AT jumps to step 1108. If the packet transmission is completed in step 1108, the AT receives the next slot in step 1109. Then, the AT determines whether the current packet will be terminated within two slots in the new slot in step 1103 and determines whether to transmit the DRC channel according to the determination result.

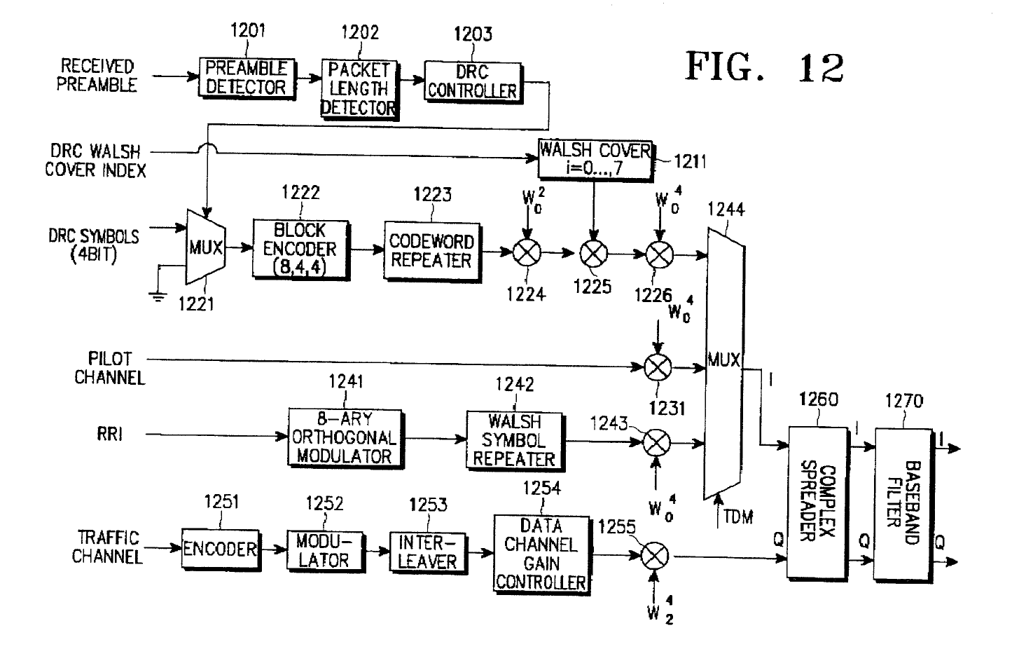

FIG. 12 is a block diagram of an AT transmitter according to the third block diagram of the present invention. The AT transmitter is characterized by control of the DRC channel of an AT that receives the current forward traffic channel. Since the transmitter structure associated with the pilot channel, the RRI channel, and the traffic channel is the same as that shown in FIG. 6, only the transmitter structure associated with determining whether to transmit the DRC symbol will be described in detail.

Referring to FIG. 12, a preamble detector 1201 detects a preamble destined for the AT. A packet length detector 1202 detects packet length from the preamble. Since a time period in which the DRC symbol must be transmitted can be known from the packet length as shown in FIG. 10, a DRC controller 1203 controls a MUX 1221 to pass the DRC symbol two slots before the packet transmission is terminated and to block the DRC symbol in the other slots. That is, if the packet length is shorter than three slots, the DRC symbol is passed all the time.

Embodiment 4

In the first and second embodiments, interference load is reduced by controlling the DRC channels of all ATs. However, since the DRC channels are transmitted with the pilot channels and the RRI channels in time division, pilot channels and RRI channels from users are transmitted at the same time points even though the DRC channels are not transmitted. As a result, the interference load is not reduced when the pilot and RRI channels are transmitted from the users. Therefore, if the pilot channels and the RRI channels are transmitted at different time points according to the users for the DRC non-transmission period, interference load can be equally distributed. This is the basic idea of Embodiment 4.

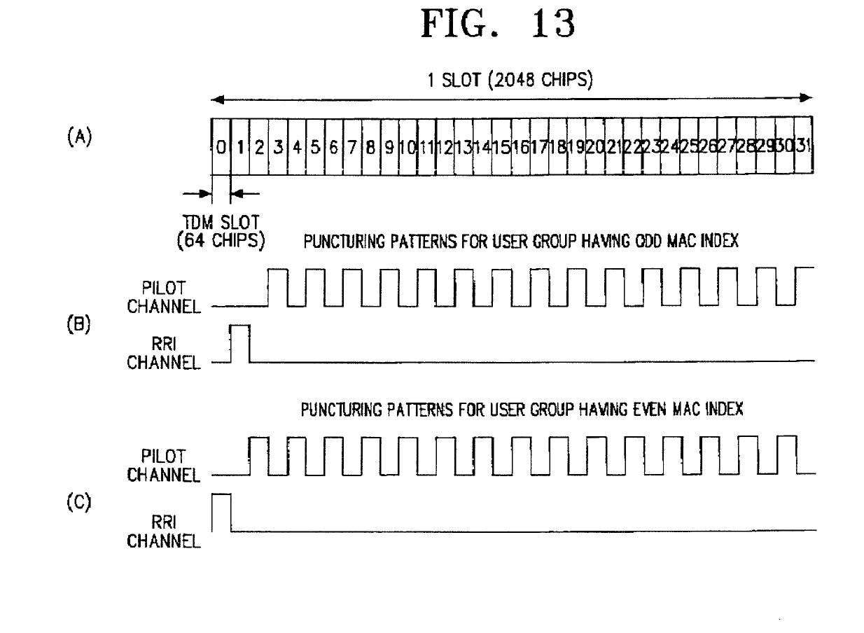

FIGS. 13A, 13B, and 13C illustrate time points at which the pilot channels and the RRI channels are transmitted for a DRC non-transmission period.

Referring to FIGS. 13A, 13B, and 13C, all ATs are grouped into ones assigned to even-numbered MAC indexes and odd-numbered MAC indexes to transmit their pilot and RRI channels at different time points. The ATs can be grouped in a different way. The odd-numbered AMC index group transmits pilots and RRI channels in odd-numbered TDM slots as shown in FIG. 13B, whereas the even-numbered AMC index group transmits pilots and RRI channels in even-numbered TDM slots as shown in FIG. 13C. The resulting equal distribution of interference load contributes to the increase of the reverse link system capacity. That is, if a plurality of ATs are divided into a first group (e.g., an odd-numbered group) and a second group (e.g., an even-numbered group), the first group terminals transmit pilot signals and RRI channels in a first group of slots (e.g., odd-numbered slots) and the second group terminals transmit pilot signals and RRI channels in a second group of slots (e.g., even-numbered slots).

The above operation can be performed independently, or in conjunction with the first to third embodiments, respectively.

In accordance with the present invention as described above, transmission of DRC channels is controlled so that DRC information is transmitted on the reverse link only when necessary in an HDR system. Therefore, interference load on the reverse link is reduced and the system capacity of the reverse link is increased. Furthermore pilot channels and RRI channels are transmitted at different time points according to users for a DRC non-transmission period, thereby further decreasing the interference load generated for the DRC non-transmission period.

While the invention has been shown and described with reference to certain preferred embodiments thereof, they are mere exemplary applications. While the embodiments have been described in the context with the HDR system, they are applicable to any telecommunication system where packet data and DRC information are transmitted. The embodiments are not limited to Walsh codes either. Therefore, it will be understood by those skilled in the art that various changes in form and details may be made therein without departing from the spirit and scope of the invention as defined by the appended claims.

What is claimed is:

1. A method of transmitting data rate control (DRC) information to an access network (AN) transmitting packet data for a first transmission period having a plurality of slots in order to request a data rate for packet data to be transmitted by the AN for a second transmission period after the first transmission period in an access terminal (AT) of a mobile telecommunication system, comprising the steps of:
receiving a DRC request indicator (DRI) bit in a predetermined slot before a last slot of the first transmission period; and
generating the DRC information in response to the DRI bit and transmitting the DRC information to the AN.

2. The method of claim 1, wherein the predetermined slot is at least two slots before the last slot.

3. The method of claim 2, wherein the predetermined slot is a first slot from the last slot and the last slot.

4. An access terminal (AT) for transmitting data rate control (DRC) information to an access network (AN) transmitting packet data for a first transmission period having a plurality of slots according to a requested data rate in order to request a data rate for packet data to be transmitted by the AN for a second transmission period after the first transmission period in a mobile telecommunication system, comprising:
a receiver for receiving a DRC request indicator (DRI) bit in a predetermined slot before a last slot of the first transmission period; and
a transmitter for selectively transmitting the DRC information according to the DRI bit to the AN.

5. The AT of claim 4, wherein the predetermined slot is at least two slots before the last slot.

6. The AT of claim 4, wherein the predetermined slot indicates the first two slots from the last slot and the last slot.

7. The AT of claim 4, wherein the transmitter comprises a selector for receiving the DRC information and selectively outputting the DRC information according to the DRI bit, and a spreader for spreading the output of the selector with a predetermined orthogonal code.

8. A method of controlling transmission of data rate control (DRC) information from an access terminal (AT) that requests a data rate for packet data in an access network (AN) that transmits the packet data at the requested data rate in a mobile telecommunication system, comprising the steps of:
checking a last slot of a first transmission period having a plurality of slots when the AN transmits the packet data to the AT for the first transmission period; and
transmitting a DRC request indicator (DRI) bit to the AT in a predetermined slot before the last slot to request DRC information to be used for a second transmission period after the first transmission period to the AT.

9. The method of claim 8, wherein the predetermined slot is at least two slots before the last slot.

10. The method of claim 8, wherein the predetermined slot indicates the first two slots from the last slot and the last slot.

11. An access network (AN) for transmitting packet data at a requested data rate to an access terminal (AT) and controlling transmission of DRC information from the AT that requests the data rate for the packet data in a mobile telecommunication system, comprising:
a controller for checking a last slot of a first transmission period having a plurality of slots when the AN transmits the packet data to the AT for the first transmission period; and
a transmitter for transmitting a DRC request indicator (DRI) bit to the AT in a predetermined slot before the last slot to request DRC information to be used for a second transmission period after the first transmission period to the AT.

12. The AN of claim 11, wherein the predetermined slot is at least two slots before the last slot.

13. The AN of claim 11, wherein the predetermined slot indicates the first two slots from the last slot and the last slot.

14. The AN of claim 11, further comprising a spreader for spreading the DRI bit with a predetermined orthogonal code.

15. A mobile telecommunication system comprising:
an access network (AN) for transmitting packet data for a first transmission period having a plurality of slots according to a requested data rate and transmitting a DRC request indicator (DRI) bit in a predetermined slot before a last slot of the first transmission period; and
an access terminal (AT) for selectively transmitting data rate control (DRC) information to the AN according to the DRI bit to request a data rate for packet data to be received for a second transmission period after the first transmission period.

16. The mobile telecommunication system of claim 15, wherein the AT comprises a receiver for receiving the DRI bit from the AN and a transmitter for selectively transmitting the DRC information to the AN according to the DRI bit.

17. The mobile telecommunication system of claim 16, wherein the transmitter comprises a selector for receiving the DRC information and selectively outputting the DRC information according to the DRI bit, and a spreader for spreading the output of the selector with a predetermined orthogonal code.

18. The mobile telecommunication system of claim 15, wherein the AN comprises a controller for checking the last slot of the first transmission period when the AN transmits the packet data to the AT for the first transmission period, and a transmitter for transmitting the DRI bit to the AT.

19. The mobile telecommunication system of claim 18, wherein the transmitter includes a spreader for spreading the DRI bit with a predetermined orthogonal code.

20. The mobile telecommunication system of claim 15, wherein the predetermined slot is at least two slots before the last slot.

21. The mobile telecommunication system of claim 15, wherein the predetermined slot indicates the first two slots from the last slot and the last slot.

22. A method of transmitting data rate control (DRC) information to an access network (AN) in an access terminal (AT) of a second group in a mobile telecommunication system having the AN for transmitting packet data at a requested data rate for a first transmission period having a plurality of slots, and a plurality of ATs divided into a first AT group that includes at least one AT for receiving the packet data for the first transmission period and a second AT group that does not receive the packet data for the first transmission period and is to receive packet data for a second transmission period after the first transmission period, the method comprising the steps of:
detecting ATs of the first group by multiplying a received preamble by a plurality of predetermined orthogonal codes assigned to the plurality of ATs;
detecting the length of the packet data transmitted to the first group of ATs for the first transmission period from the preamble and checking a last slot of the first transmission period; and
generating the DRC information in a predetermined slot before the last slot and transmitting the DRC information to the AN.

23. The method of claim 22, wherein the predetermined slot is at least two slots before the last slot.

24. The method of claim 22, wherein the predetermined slot indicates the first two slots from the last slot and the last slot.

25. An access terminal (AT) of a second group for transmitting data rate control (DRC) information to an access network (AN) in a mobile telecommunication system having the AN for transmitting packet data at a requested data rate for a first transmission period having a plurality of slots, and a plurality of ATs divided into a first AT group that includes at least one AT for receiving the packet data for the first transmission period and a second AT group that does not receive the packet data for the first transmission period and is to receive packet data for a second transmission period after the first transmission period, comprising:
a multiplier for detecting ATs of the first group by multiplying a received preamble by a plurality of predetermined orthogonal codes assigned to the plurality of ATs;
a packet length detector for detecting the length of the packet data transmitted to the first group of ATs for the first transmission period from the preamble;
a controller for checking a last slot of the first transmission period; and
a transmitter for selectively transmitting the DRC information in a predetermined slot before the last slot to the AN under the control of the controller.

26. The AT of claim 25, wherein the predetermined slot is at least two slots before the last slot.

27. The AT of claim 25, wherein the predetermined slot indicates the first two slots from the last slot and the last slot.

28. The AT of claim 25, further comprising an accumulator for accumulating the multiplication result received from the multiplier and an energy detector for detecting an energy value corresponding to the accumulation result and feeding the energy value to the packet length detector.

29. The AT of claim 25, wherein the transmitter comprises a selector for receiving the DRC information and selectively outputting the DRC information under the control of the controller, and a spreader for spreading the output of the selector with a predetermined orthogonal code.

30. A method of transmitting data rate control (DRC) information to an access network (AN) in an access terminal (AT) of a first group in a mobile telecommunication system having the AN for transmitting packet data at a requested data rate for a first transmission period having a plurality of slots, and a plurality of ATs divided into the first AT group that includes at least one AT for receiving the packet data for the first transmission period and a second AT group that does not receive the packet data for the first transmission period and is to receive packet data for a second transmission period after the first transmission period, the method comprising the steps of:
checking a last slot of the first transmission period; and
generating the DRC information in a predetermined slot before the last slot and transmitting the DRC information to the AN.

31. The method of claim 30, wherein the predetermined slot is at least two slots before the last slot.

32. The method of claim 30, wherein the predetermined slot indicates the first two slots from the last slot and the last slot.

33. An access terminal (AT) of a first group for transmitting data rate control (DRC) information to an access network (AN) in a mobile telecommunication system having the AN for transmitting packet data at a requested data rate for a first transmission period having a plurality of slots, and a plurality of ATs divided into the first AT group that includes at least one AT for receiving the packet data for the first transmission period and a second AT group that does not receive the packet data for the first transmission period and is to receive packet data for a second transmission period after the first transmission period, comprising:
a preamble detector for detecting a preamble;
a packet length detector for detecting the length of the packet data received for the first transmission period from the preamble;
a controller for checking a last slot of the first transmission period based on the packet length; and
a transmitter for selectively transmitting the DRC information in a predetermined slot before the last slot to the AN under the control of the controller.

34. The AT of claim 33, wherein the predetermined slot is at least two slots before the last slot.

35. The AT of claim 33, wherein the predetermined slot indicates the first two slots from the last slot and the last slot.

36. The AT of claim 33, wherein the transmitter comprises a selector for receiving the DRC information and selectively outputting the DRC information under the control of the controller, and a spreader for spreading the output of the selector with a predetermined orthogonal code.

37. An access terminal (AT) in a mobile telecommunication system, comprising:
a multiplier for sequentially multiplying a received preamble by a plurality of orthogonal codes assigned to a plurality of ATs;
a detector for detecting an AT receiving packet data and the length of the packet data from the multiplication result;
a controller for determining the termination period of packet data transmission based on the packet length; and
a transmitter for selectively transmitting data rate control (DRC) information in a predetermined period to an access network (AN) before the termination period.

38. The AT of claim 37, wherein if the transmission period includes a plurality of slots, the predetermined period is at least two slots before a last slot.

39. The AT of claim 37, wherein if the transmission period includes a plurality of slots, the predetermined period indicates the first two slots from a last slot and the last slot.

40. A method of transmitting a signal to an access network (AN) in a plurality of access terminals (ATs) divided into a first group and a second group, for selectively transmitting data rate control (DRC) information to the AN in a mobile telecommunication system, comprising the steps of:
checking whether the ATs transmit the DRC information;
transmitting reverse rate indicators (RRIs) and pilot signals to the AN in a predetermined first group of slots among a plurality of multiplexed slots by the first group of ATs if the DRC information is not transmitted; and
transmitting RRIs and pilot signals to the AN in a second group of slots by the second group of ATs if the DRC information is not transmitted, the second group of slots being the remaining slots from the plurality of multiplexed slots minus the first group of slots.

41. The method of claim 40, wherein the first group slots are an odd-numbered slots of the multiplexed slots.

42. The method of claim 40, wherein the second group slots are an even-numbered slots of the multiplexed slots.
